(19) United States
(12) Patent Application Publication
(10) Pub. No.: US 2006/0152542 A1
(43) Pub. Date: Jul. 13, 2006

(54) System and method for performing measurements on a target medium

(76) Inventor: Gary Joseph Dispoto, Mountain View, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/033,240

(22) Filed: Jan. 11, 2005

(51) Int. Cl. B41J 29/393

(52) U.S. Cl. 347/19

(57) ABSTRACT

A system and method for performing measurements on a target medium utilizes a measurement apparatus having optoelectronic and electrical components to make the measurements. The measurement apparatus has a configuration of a printer cartridge such that the measurement apparatus can be installed in a cartridge carriage of a printer.

### FIELD OF THE INVENTION

The invention relates generally to measurement devices, and more particularly to a color measurement device.

### BACKGROUND OF THE INVENTION

Color inkjet printers produce color reproductions by depositing varying amounts of different color inks onto printing media, e.g., glossy photo papers. In order to ensure proper color reproductions are produced, a color printer is typically calibrated with a color look-up table provided by the printer manufacturer. This color look-up table is used by the color printer to determine the ratio of different color inks to reproduce a specific digital color onto a printing medium.

The use of a color look-up table provided by the printer manufacturer results in proper color reproductions for most situations. However, over time, color printers tend to drift with respect to printed color, which degrades the color integrity of color reproductions produced by the color printers. Furthermore, the use of different types of color inks and/or different types of media may affect the printed color, which reduces the effectiveness of the color look-up tables provided by the printer manufacturers. These issues of printed color for color printers can be alleviated by recalibrating the color printers by creating and using a new color look-up table that takes into consideration color drift and types of ink and media currently being used.

Color look-up tables can be created using color measurement devices that measure color characteristic of a colored test pattern printed using particular types of inks on a particular type of media (“test sheet”). A common color measurement device is a handheld device that can be used to manually scan a test sheet to measure different colors at various areas of the test sheet. The color measurements are then used to produce a color look-up table. Another common color measurement device is a tabletop device that automatically scans a test sheet to also measure different colors at various areas of the test sheet.

A concern with the handheld color measurement device is that the process of taking color measurements using this device is tedious, time consuming and may introduce human errors into the resulting color look-up table. A concern with the tabletop color measurement device is that this device is very expensive, which effectively limits the use of such a device to high end users.

In view of these concerns, there is a need for a system and method for performing color measurements that is cost effective and does not require a manual scanning operation.

### SUMMARY OF THE INVENTION

A system and method for performing measurements on a target medium utilizes a measurement apparatus having optoelectronic and electrical components to make the measurements. The measurement apparatus has a configuration of a printer cartridge such that the measurement apparatus can be installed in a cartridge carriage of a printer.

A measurement apparatus in accordance with an embodiment of the invention comprises a housing having a configuration that substantially conforms to a printer cartridge such that the measurement apparatus can be installed in a cartridge carriage of a printer, and optoelectronic and electrical components supported by the housing that are configured to make single measurements at different non-contiguous locations of a target medium that can be used to enhance performance of a selected printer.

A measuring system in accordance with an embodiment of the invention comprises a printer having a cartridge carriage in which a printer cartridge can be installed, and a measurement apparatus having a configuration of the printer cartridge such that the measurement apparatus can be installed in the cartridge carriage. The printer is configured to move the cartridge carriage to scan a target medium. The measurement apparatus includes optoelectronic and electrical components configured to make single measurements at different non-contiguous locations of the target medium that can be used to enhance performance of a selected printer.

A method for performing measurements on a target medium in accordance with an embodiment of the invention comprises providing a measurement apparatus in a cartridge carriage of a printer, the measurement apparatus including optoelectronic and electrical components configured to make measurements of the target medium, and moving the cartridge carriage to scan the target medium with the measurement apparatus in the cartridge carriage, including making measurements at different locations of the target medium using the measurement apparatus.

Other aspects and advantages of the present invention will become apparent from the following detailed description, taken in conjunction with the accompanying drawings, illustrated by way of example of the principles of the invention.

### BRIEF DESCRIPTION OF THE DRAWINGS

FIG. 1 is a diagram of a printing and measuring system in accordance with an embodiment of the invention.

FIG. 2 is a block diagram of a measurement apparatus included in the system of FIG. 1 in accordance with an embodiment of the invention.

FIG. 3A is a diagram of a light source and a photodetector included in the measurement apparatus of FIG. 2 in accordance with an implementation of the invention.

FIG. 3B is a diagram of a light source and a photodetector included in the measurement apparatus of FIG. 2 in accordance with another implementation of the invention.

FIG. 4 is a diagram of a measurement apparatus in accordance with another embodiment of the invention.

FIG. 5 is a process flow diagram of a method for performing measurements in accordance with an embodiment of the invention.

### DETAILED DESCRIPTION

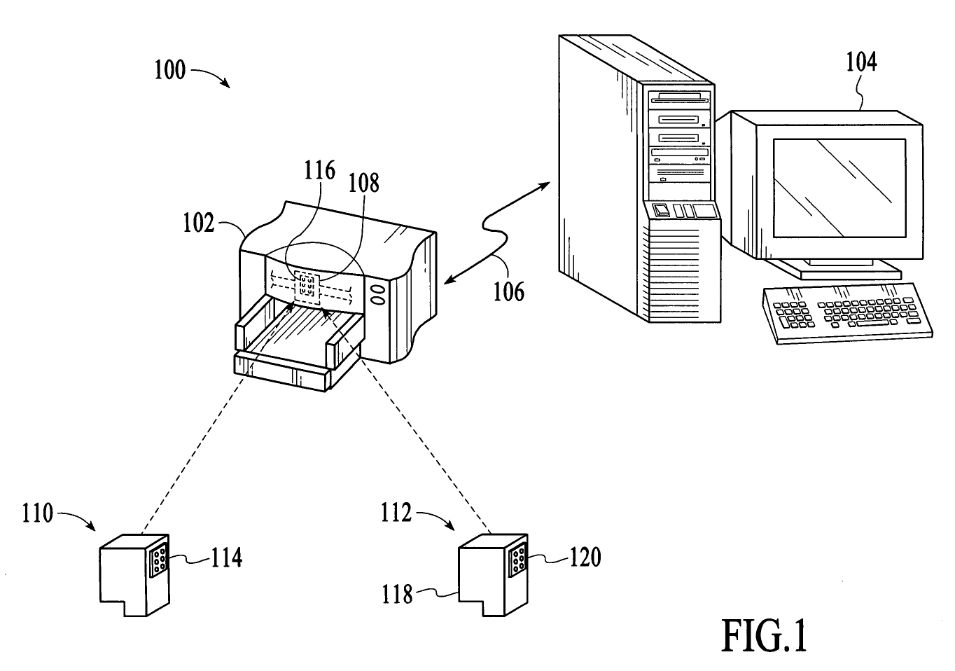

With reference to FIG. 1, a printing and measuring system 100 in accordance with an embodiment of the invention is described. The printing and measuring system 100 can print reproductions on media, e.g., sheets of paper. Furthermore, the printing and measuring system 100 can also make measurements of a target medium, such as a test sheet on which a pattern of different colors is printed. The resulting measurements can be used to enhance the performance of the printer used to produce the test sheet. As an example, the resulting measurements can be used to create a new color look-up table, which takes into consideration color drift of the color printer used to produce the test sheet, the types of inks used to produce the test sheet and the type of media used for the test sheet.

The printing and measuring system 100 includes a printer 102 that is connected to a computer 104 via a wired or wireless connection 106. In an embodiment, the printer 102 is a color printer. However, the printer 102 may be a black-and-white printer. The printer 102 includes components that are commonly found in conventional inkjet printers, such as a paper tray, mechanisms for moving one or more papers, a cartridge carriage 108, mechanisms for laterally displacing the cartridge carriage, and various electrical components. In FIG. 1, only the cartridge carriage 108 of the printer 102 is identified. The cartridge carriage 108 is designed to hold one or more inkjet printer cartridges.

The printing and measuring system 100 further includes an inkjet printer cartridge 110 and a measurement apparatus 112. The inkjet printer cartridge 110 is designed to be installed in the cartridge carriage 108 of the printer 102. The inkjet printer cartridge 110 includes one or more reservoirs to hold different color inks, e.g., cyan, magenta, yellow and black inks. The inkjet printer cartridge 110 also includes electrical contacts 114 that are similar to electrical contacts 116 on the cartridge carriage 108. When the inkjet printer cartridge 110 is installed in the cartridge carriage 108 of the printer 102, the electrical contacts 114 of the inkjet printer cartridge and the electrical contacts 116 of the cartridge carriage 108 connect to provide electrical connections between the inkjet printer cartridge and the printer.

Similar to the inkjet printer cartridge 110, the measurement apparatus 112 is also designed to be installed in the cartridge carriage 108 of the printer 102. The measurement apparatus 112 includes optoelectronic and electrical components (not shown in FIG. 1) to take measurements on a target medium, which can be used, for example, to calibrate the color printer 102 by generating a new color look-up table for the color printer. The optoelectronic and electrical components of the measurement apparatus 112 are supported by a printer cartridge housing 118 having a shape or configuration similar to the inkjet printer cartridge 110. That is, the configuration of the measurement apparatus 112 substantially conforms to the configuration of the inkjet printer cartridge 110. Thus, the measurement apparatus 112 can be installed in the cartridge carriage 108 of the printer 102 in place of the inkjet printer cartridge 110. The measurement apparatus 112 also includes electrical contacts 120 on the printer cartridge housing 118 that connect to the electrical contacts 116 of the cartridge carriage 108 when the measurement apparatus is installed in the cartridge carriage of the printer 102.

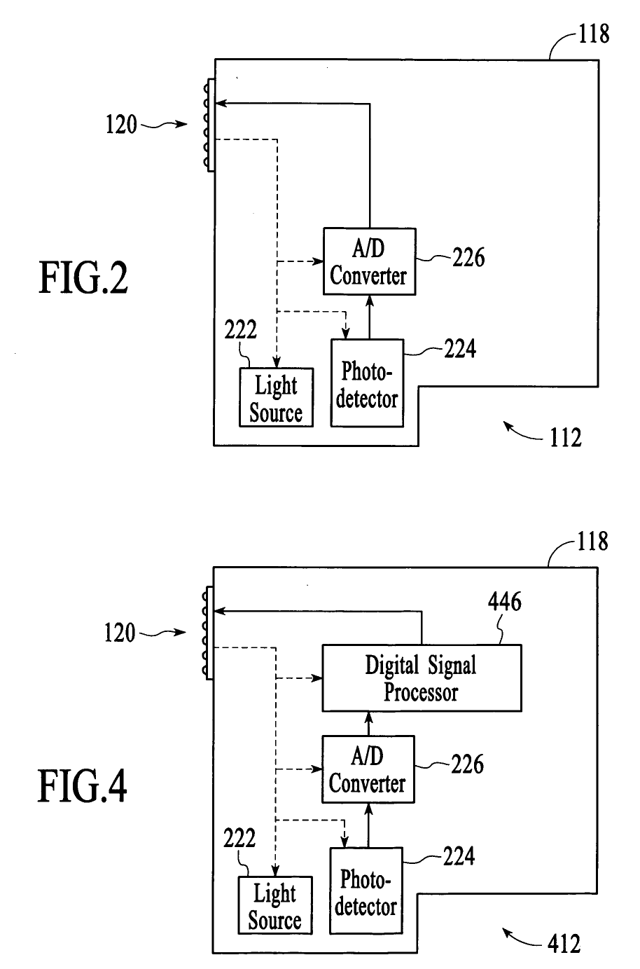

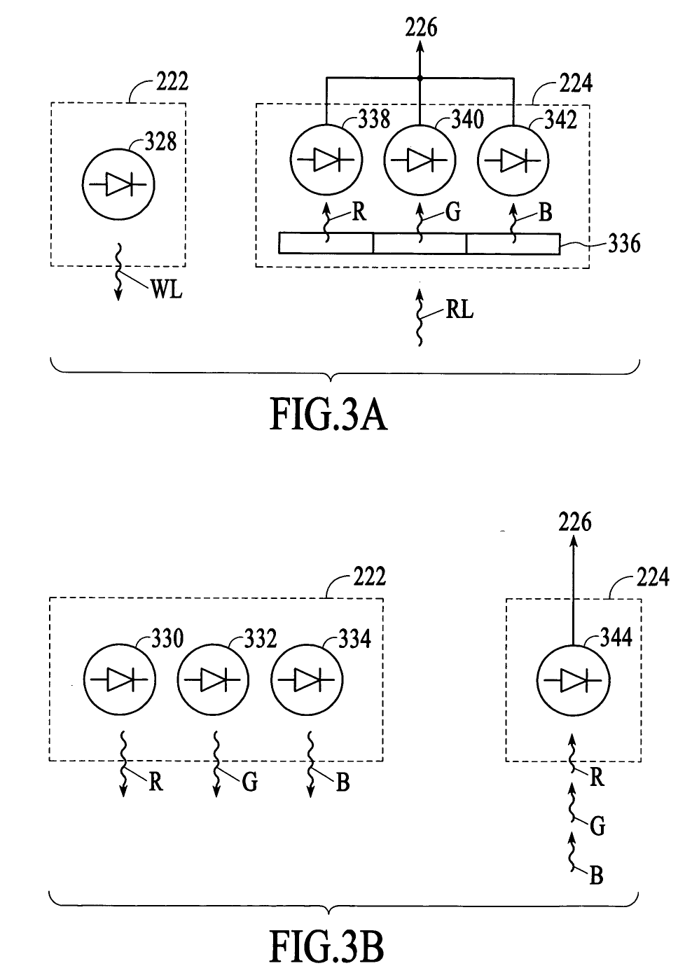

The measurement apparatus 112 in accordance with an embodiment of the invention is further described with reference to a block diagram of FIG. 2. As shown in FIG. 2, the measurement apparatus 112 includes the printer cartridge housing 118, a light source 222, a photodetector 224, an analog-to-digital (A/D) converter 226 and the electrical contacts 120. The light source 222 of the measurement apparatus 112 provides illumination so that reflected light from a target surface, e.g., the surface of a test sheet, can be sampled to measure the color at the surface. In an implementation, the light source 22 may provide white color light. In this implementation, the light source 222 may include a light emitting diode 328 that generates white color light WL, as illustrated in FIG. 3A. In another implementation, the light source 222 may sequentially provide different color lights, such as red, green and blue lights. In this implementation, the light source 222 may include three light emitting diodes 330, 332 and 334 that generate red light R, green light G and blue light B, as illustrated in FIG. 3B.

The photodetector 224 of the measurement apparatus 112 receives light reflected off at different non-contiguous locations of a target surface, e.g., the surface of a test sheet, and generates analog signals in the form of electrical currents that correspond to the intensity of the reflected light with respect to different colors. Thus, the photodetector 224 is configured to make a single color measurement at a particular location of the target surface. In the implementation with the light source 222 that provides white color light WL, the photodetector 224 may include a color filter 336 and three photodiodes 338, 340 and 342 that are optically coupled to the color filter, as illustrated in FIG. 3A. The color filter 336 selectively transmits different color components of received light RL, e.g., red light R, green light G and blue light B, to the photodiodes 338, 340 and 342. Thus, each of the photodiodes 338, 340 and 342 measures the intensity of the reflected light of a particular color. Using all the signals generated by the photodiodes 338, 340 and 342, the color at a particular location of the target surface can be determined. In the implementation with the light source 222 that sequentially provides different color lights R, G and B, the photodetector 224 may include a single photodiode 344 that sequentially measures the intensity of each reflected color light, as illustrated in FIG. 3B.

The A/D converter 226 of the measurement apparatus 112 converts the analog signals generated by the photodetector 224 to digital signals. The A/D converter 226 is connected to the electrical contacts 120 to transmit the digital signals to the printer 102 via the electrical contacts 120. The electrical contacts 120 of the measurement apparatus 112 is designed to physically touch or contact the corresponding electrical contacts 116 on the cartridge carriage 108 of the printer 102 when the measurement apparatus is installed in the cartridge carriage. Consequently, signal communications between the measurement apparatus 112 and the printer 102 are possible by the connections provided by the electrical contacts 116 and 120 of the cartridge carriage 108 and the measurement apparatus 112. Some of the electrical connections provided by the electrical contacts 116 and 120 of the cartridge carriage 108 and the measurement apparatus 112 are used to transmit the digital signals relating to measurements, while some of the electrical connections are used to receive control signals from the printer 102 and/or the computer 104. Furthermore, at least one of the connections between the electrical contacts 116 and 120 of the cartridge carriage 108 and the measurement apparatus 112 provides electrical power from the color printer 102 to the measurement apparatus 112. As illustrated by the dotted arrows in FIG. 2, the electrical power received at the measurement apparatus 112 through the electrical contacts 120 is distributed to all the components of the measurement apparatus that require electrical power. Thus, the measurement apparatus 112 does not need to have an independent power supply of its own. Alternatively, the measurement apparatus 112 may have its own power supply.

The printing and measuring operations of the printing and measuring system 100 are now described. The printing operation of the system 100 is similar to the printing operation of other systems that include a computer and an inkjet printer. In order to print, the inkjet printer cartridge 110 is installed in the cartridge carriage 108 of the printer 102. The printing operation is typically initiated by entering a command on an application running on the computer 104, such as a word or image processing application. A computer file that represents an electric document or a digital image is then converted to print drive signals by a print driver installed on the computer 104. The print drive signals are then transmitted to the printer 102, where the print drive signals are used to selectively activate the inkjet printer cartridge 110 via the connections provided by the electrical contacts 114 and 116 of the inkjet printer cartridge 110 and the cartridge carriage 108 to discharge different color inks onto a sheet of media, e.g., a sheet of glossy paper. The printer 102 is able to deposit different color inks at selected locations on a sheet of media by coordinating the activation of the inkjet printer cartridge 110, the movement of the sheet of media and the movement of the cartridge carriage 108 in which the inkjet printer cartridge is installed.

The measuring operation of the printing and measuring system 100 is similar to the printing operation. In order to take measurements, the inkjet printer cartridge 110 is removed from the cartridge carriage 108 of the printer 102 and the measurement apparatus 112 is installed in the cartridge carriage. A test sheet is then placed in the paper tray of the printer 102 such that the test sheet is the next sheet to be processed (picked up) by the printer. Alternatively, the test sheet may be manually fed into the printer 102. The test sheet is a sheet of media on which a test pattern of different colors is printed. The test sheet may have been produced by the printer 102. In this case, the resulting color measurements can be used to enhance the performance of the printer 102 by, for example, producing a color look-up table to be used by the printer 102. Alternatively, the test sheet may have been produced by another printer. In this case, the resulting measurements can be used to enhance the performance of that printer by, for example, producing a color look-up table to be used by that printer.

Next, the measuring operation is initiated by entering a command on a supporting application running on the computer 104. The supporting application provides a user interface to perform the measuring operation. Alternatively, the user interface may be implemented within the printer 102 itself. The supporting application also controls the printer 102, including the measurement apparatus 112. After the command has been entered, the supporting application transmits control signals to the printer 102 to selectively move the test sheet, to selectively move the cartridge carriage 108 and to selectively activate the measurement apparatus 112. The movements of the test sheet and the cartridge carriage 108 and the activation of the measurement apparatus 112 are coordinated so that different non-contiguous locations of the test sheet having different printed colors are measured with respect to color. Thus, the measurement apparatus 112 is able to scan the test sheet and make single color measurements at desired non-contiguous locations on the test sheet. Alternatively, the measurement operation may be automatically initiated upon insertion of the measurement apparatus 112 into the cartridge carriage 108.

The activation of the measurement apparatus 112 involves turning on the light source 222 to provide illumination on the surface of the test sheet, which may be achieved by generating white color light using the light emitting diode 328 of FIG. 3A or sequentially generating different color lights using the light emitting diodes 330, 332 and 334 of FIG. 3B. The light that is reflected off the surface of the test sheet is then received by the photodetector 224, which generates analog signals in the form of electrical currents. If the light source 222 provides white color light, then the photodetector 224 filters the reflected light to selectively receive different color components of the reflected light, such as red, green and blue lights, using the color filter 336 of FIG. 3A, and generates analog signals in response to the different received color components using the photodiodes 338, 340 and 342. If the light source 222 sequentially provides different color lights, the photodetector 224 sequentially receives these different color lights reflected off the surface of the test sheet, and generates an analog signal for each of the received color light using the photodiode 334 of FIG. 3B. As described above, the analog signals are converted to digital signals by the A/D converter 226 and are transmitted to the computer 104 via the color printer 102.

The digital signals from the measurement apparatus 112, which represent single color measurements at various non-contiguous locations on the test sheet, are processed by the supporting application running on the computer 104 to, for example, produce a new color look-up table. Alternatively, the digital signals may be processed by an application running in the printer 102. The techniques for producing color look-up tables from color measurements are well known, and thus, are not described herein. The new color look-up table can be used to calibrate the printer 102, if the test sheet was produced using the printer 102. Alternatively, the new color look-up table can be used to calibrate another printer, if the test sheet was produced using that printer.

Turning now to FIG. 4, a measurement apparatus 412 in accordance with another embodiment of the invention is shown. In FIG. 4, the same reference numerals of FIG. 2 are used to identify similar elements. As shown in FIG. 4, the measurement apparatus 412 in this embodiment further includes a digital signal processor 446 that processes the digital signals of the color measurements from the A/D converter 226 to, for example, produce a color look-up table. The digital signal processor 446 can be any type of a processor having enough processing power to produce a color look-up table from color measurements. Thus, in this embodiment, there is no need to transfer the digital signals of the color measurements to the computer 104 via the printer 102. The digital signals can be processed at the measurement apparatus 412 to produce a new color look-up table, which can be transmitted to the printer 102 to replace the existing color look-up table being used by the printer.

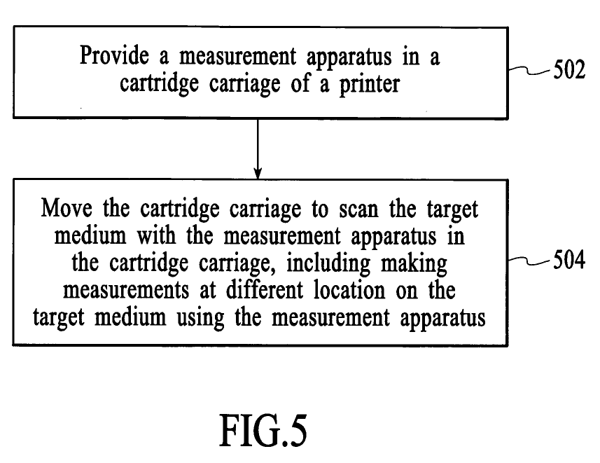

A method for performing measurements in accordance with an embodiment of the invention is described with reference to a process flow diagram of FIG. 5. At block 502, a measurement apparatus in a cartridge carriage of a printer is provided. The measurement apparatus includes optoelectronic and electrical components configured to make measurements of a target medium, e.g., a test sheet. Next, at block 504, the cartridge carriage is moved to scan the target medium with the measurement apparatus in the cartridge carriage. Furthermore, measurements are made at different locations of the target medium using the measurement apparatus. The measurements may be processed to produce a color look-up table to be used by a selected printer, which may be the current printer being used to make the color measurements.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A measurement apparatus comprising:
a housing having a configuration that substantially conforms to a printer cartridge such that said measurement apparatus can be installed in a cartridge carriage of a printer; and
optoelectronic and electrical components supported by said housing, said optoelectronic and electrical components being configured to make single measurements at different non-contiguous locations of a target medium that can be used to enhance performance of a selected printer.

2. The apparatus of claim 1 wherein said housing has a configuration that substantially conforms to an inkjet printer cartridge.

3. The apparatus of claim 1 wherein said optoelectronic and electrical components include a light source that provides illumination and a photodetector that generates signals related to said single measurements in response to received light.

4. The apparatus of claim 3 wherein said light source is configured to generate white color light and wherein said photodetector is configured to generate said signals in response to different color components of said received light.

5. The apparatus of claim 3 wherein said light source is configured to sequentially generate different color lights and wherein said photodetector is configured to sequentially generate said signals in response to different received color lights.

6. The apparatus of claim 1 further comprising electrical contacts located on said housing such that said electric contacts form electrical connections with corresponding electrical contacts on said cartridge carriage of said printer when said measurement apparatus is installed in said cartridge carriage, said electrical contacts being connected to at least one of said optoelectronic and electrical components.

7. The apparatus of claim 1 wherein said optoelectronic and electrical components include a digital signal processor that is configured to process said single color measurements to produce a color look-up table at said apparatus.

8. A measuring system comprising:
a printer having a cartridge carriage in which a printer cartridge can be installed, said printer being configured to move said cartridge carriage to scan a target medium; and
a measurement apparatus having a configuration of said printer cartridge such that said measurement apparatus can be installed in said cartridge carriage, said measurement apparatus including optoelectronic and electrical components configured to make single measurements at different non-contiguous locations of said target medium that can be used to enhance performance of a selected printer.

9. The system of claim 8 wherein said measurement apparatus has a configuration that substantially conforms to an inkjet printer cartridge.

10. The system of claim 8 wherein said optoelectronic and electrical components of said measurement apparatus include a light source that provides illumination and a photodetector that generates signals related to said signal color measurements in response to received light.

11. The system of claim 10 wherein said light source is configured to generate white color light and wherein said photodetector is configured to generate said signals in response to different color components of said received light.

12. The system of claim 10 wherein said light source is configured to sequentially generate different color lights and wherein said photodetector is configured to sequentially generate said signals in response to different received color lights.

13. The system of claim 8 wherein said measurement apparatus further includes electrical contacts that are located on said measurement apparatus such that said electric contacts form electrical connections with corresponding electrical contacts on said cartridge carriage of said printer when said measurement apparatus is installed in said cartridge carriage, said electrical contacts being connected to at least one of said optoelectronic and electrical components.

14. The system of claim 8 wherein said optoelectronic and electrical components of said measurement apparatus include a digital signal processor that is configured to process said single color measurements to produce a color look-up table at said measurement apparatus.

15. A method for performing measurements on a target medium, said method comprising:
providing a measurement apparatus in a cartridge carriage of a printer, said measurement apparatus including optoelectronic and electrical components configured to make said measurements of said target medium; and
moving said cartridge carriage to scan said target medium with said measurement apparatus in said cartridge carriage, including making said measurements at different locations of said target medium using said measurement apparatus.

16. The method of claim 15 wherein said making of said measurements includes making single color measurements at different non-contiguous locations of said target medium using said measurement apparatus.

17. The method of claim 15 further comprising processing said measurements to produce a color look-up table to be used by a selected printer.

18. The method of claim 17 wherein said processing of said measurements is performed at said measurement apparatus to produce said color look-up table.

19. The method of claim 17 wherein said processing of said measurements is performed at a computer connected to said printer to produce said color look-up table.

20. The method of claim 15 wherein said making of said color measurements includes providing illumination and generating signals related to said color measurements in response to received light.

21. The method of claim 20 further comprising transmitting said signals from said measurement apparatus to a computer connected to said printer to be processed.

22. A measurement apparatus comprising:
a housing having a configuration that substantially conforms to a printer cartridge such that said measurement apparatus can be installed in a cartridge carriage of a printer; and
means for making single measurements at different non-contiguous locations of a target medium that can be used to enhance performance of a selected printer, said means being contained within said housing.
